(19) United States
(12) Patent Application Publication
(10) Pub. No.: US 2013/0301317 A1
(43) Pub. Date: Nov. 14, 2013

(54) SWITCHING POWER SUPPLY DEVICE

(71) Applicant: PANASONIC CORPORATION, Osaka (JP)

(72) Inventor: Takuya ISHII, Osaka (JP)

(21) Appl. No.: 13/945,712

(22) Filed: Jul. 18, 2013

Related U.S. Application Data
(63) Continuation of application No. PCT/JP2011/006400, filed on Nov. 17, 2011.

(30) Foreign Application Priority Data
Jan. 25, 2011 (JP) 2011-012523

(51) Int. Cl. H02M 7/06

(52) U.S. Cl. CPC H02M 7/062
USPC 363/44

(57) ABSTRACT

Provided is a switching power supply device capable of sufficiently removing ripple noise due to the switching frequency, the ripple noise being superimposed on an AC line, thereby stabilizing an output voltage. The switching power supply device includes: a switch including a first main terminal and a second main terminal, the first main terminal being connected to an inductor, the second main terminal being connected to a predetermined constant power supply unit, the switch being configured to connect or disconnect between the inductor and the constant power supply unit; and a control circuit configured to drive the switch at a predetermined switching frequency. The control circuit varies the switching frequency in accordance with a ratio of a connected time of the switch to a disconnected time of the switch.

This is a continuation application under 35 U.S.C 111(a) of pending prior International Application No. PCT/JP2011/006400, filed on Nov. 17, 2011.

### BACKGROUND OF THE INVENTION

1. Field of the Invention

The present invention relates to a switching power supply device configured to perform a PFC (Power Factor Correction) operation, which is an operation of supplying a DC voltage to a load while correcting the power factor of a voltage inputted from an AC power supply. The present invention particularly relates to a switching power supply device to which noise reduction technology utilizing frequency spreading is applied.

2. Description of the Related Art

Regarding switching power supply devices configured to perform an PFC operation of supplying a DC voltage to a load based on a voltage inputted from an AC power supply, there is a known configuration in which a switching frequency is varied in accordance with the input voltage (see the specification of U.S. Patent No. 5,459,392, for example).

FIG. 7 is a circuit diagram showing a configuration of a conventional switching power supply device. As shown in FIG. 7, an AC voltage Va from an input AC power supply 201 is supplied to a full-wave rectifier circuit 203 via an input filter 202, and is subjected to full-wave rectification by the full-wave rectifier circuit 203. A resultant rectified voltage Vi is converted by a boost converter 210 into an output DC voltage Vo, and is then outputted. The boost converter 210 includes: an inductor 240, a switch 241, a diode 242, an output capacitor 243, and a control circuit 211. The boost converter 210 is configured such that, when the switch 241 is in an ON state, the boost converter 210 applies the rectified voltage Vi to the inductor 240 to store energy, and when the switch 241 is in an OFF state, the boost converter 210 releases the energy stored in the inductor 240 as a current for charging the output capacitor 243 via the diode 242. Thus, the boost converter 210 supplies the output DC voltage Vo to a load circuit 205 from the output capacitor 243 through a switching operation of the switch 241. Here, a current flowing through the inductor 240 contains a ripple component which increases and decreases in accordance with switching operations of the switch 241. However, since the inductor current is averaged by the input filter 202, ripple noise in an alternating current flowing through the input AC power supply 201 is suppressed.

The control circuit 211 drives the switch 241 with a drive pulse corresponding to a switching frequency set by a resistance element 245 and a capacitor 246. At the time, the control circuit 211 adjusts the width of the drive pulse to the switch 241, such that the average value of the current flowing through the inductor 240 is proportional to the rectified voltage Vi, while stabilizing the output DC voltage Vo. A resistance element 247 is connected between an output of the full-wave rectifier circuit 203 and the capacitor 246. Accordingly, a charging current to the capacitor 246 increases in accordance with an increase in the rectified voltage Vi. Therefore, a current flowing through the resistance element 247 is added to a current value set by the resistance element 245. As a result, the period of charging of the capacitor 246 varies depending on the rectified voltage Vi. Thus, according to the conventional configuration as shown in FIG. 7, modulation is performed such that the switching frequency increases in accordance with an increase in the rectified voltage Vi, and thereby the frequency of noise arising due to a switching operation is spread, so that the noise is suppressed.

It should be noted that other known conventional switching power supplies configured to modulate the switching frequency in accordance with the level of an input AC voltage to spread the frequency of occurring noise as described above are disclosed in the specifications of Japanese Laid-Open Patent Application Publication No. 2005-295637 and U.S. Pat. No. 7,196,917.

### SUMMARY OF THE INVENTION

However, in the above-described conventional switching power supply device, since the switching frequency is modulated in accordance with the level of an input AC voltage, there is a problem in that ripple noise due to the switching frequency, the ripple noise being superimposed on an AC line, cannot be sufficiently removed by the input filter, and thus an output voltage cannot be stabilized sufficiently. In particular, in recent years, there is a tendency for the time constant of an inductor to be lower and for the switching frequency to be higher due to, for example, reduction in device size and increase in device operation speed. In such a compact switching power supply device operating at high-speed, there is a tendency for the influence of ripple noise superimposed on an AC line to be relatively great and non-negligible.

The present invention has been made to solve the above conventional problems. An object of the present invention is to provide a switching power supply device capable of sufficiently removing ripple noise due to the switching frequency, the ripple noise being superimposed on an AC line, thereby stabilizing an output voltage.

A switching power supply device according to the present invention includes: an input filter configured to filter an input AC output from an AC power supply; a full-wave rectifier circuit configured to perform full-wave rectification of the filtered input AC output; an inductor whose one end is connected to an output terminal of the full-wave rectifier circuit; a rectifier connected to another end of the inductor and configured to rectify a current outputted from the inductor; an output capacitor connected to an output terminal of the rectifier, the output capacitor being configured to be charged in accordance with the current outputted from the inductor and generate an output DC voltage outputted to a load circuit; a switch including a first main terminal and a second main terminal, the first main terminal being connected to the other end of the inductor, the second main terminal being connected to a predetermined constant power supply unit, the switch being configured to connect or disconnect between the inductor and the constant power supply unit; and a control circuit configured to drive the switch at a predetermined switching frequency. The control circuit is configured to vary the switching frequency in accordance with a ratio of a connected time of the switch to a disconnected time of the switch, and the control circuit varies the switching frequency such that the closer the ratio of the connected time of the switch to the disconnected time of the switch is to a predetermined setting value, the higher the switching frequency.

Generally speaking, an input filter used in a switching power supply device is a low-pass filter configured to remove ripple noise due to the switching frequency from an AC line. Therefore, it is considered that the lower the switching frequency of the switching power supply device, the lower the noise attenuation rate. In conventional switching power supply devices, the switching frequency is modulated in accordance with an input AC voltage regardless of the amplitude of a current flowing through an inductor. Accordingly, in a case where ripple noise becomes great due to an increase in the amplitude of the current flowing through the inductor, a state where the switching frequency is lowered may occur. Therefore, in conventional switching power supply devices, it is considered that in a case where the amplitude of the current flowing through the inductor has increased, if the switching frequency is lowered, then the effect of noise attenuation by an input filter is reduced, resulting in an increase in ripple noise superimposed on an AC line.

Meanwhile, in the switching power supply device with the above-described configuration, the switching frequency varies in accordance with the ratio of the connected time of the switch to the disconnected time of the switch (connected time/disconnected time). It is considered that the amplitude of the current flowing through the inductor varies in accordance with the ratio of the connected time to the disconnected time. Therefore, by varying the switching frequency in accordance with the ratio of the connected time to the disconnected time, the switching frequency when the ripple component of the inductor current is great can be made high. Accordingly, the ripple component of the inductor current can be effectively removed by the input filter. Consequently, ripple noise due to the switching frequency, the ripple noise being superimposed on an AC line, is sufficiently removed, and an output voltage can be stabilized.

The predetermined setting value may be a value set within a predetermined range which is not less than 0.7 and not more than 1.3. Furthermore, the control circuit may be configured to vary the switching frequency such that the closer the ratio of the connected time of the switch to the disconnected time of the switch is to 1, the higher the switching frequency.

It is considered that, ideally, the closer the ratio of the connected time of the switch to the disconnected time of the switch is to 1 (i.e., the closer the connected time-disconnected time ratio is to 1:1), the greater the amplitude of the current flowing through the inductor. Therefore, ideally, current ripple can be reduced more effectively by varying the switching frequency such that the closer the ratio of the connected time of the switch to the disconnected time of the switch is to 1, the higher the switching frequency. Moreover, when the switching frequency is varied in accordance with the ratio of the connected time of the switch to the disconnected time of the switch, the current flowing through the inductor varies, and the amplitude of the current varies, accordingly. Therefore, in reality, there is a case where the amplitude of the current becomes greatest when the ratio of the connected time of the switch to the disconnected time of the switch is not at 1 but at a slightly shifted value. In view of this, ripple noise can be removed more effectively by performing setting such that the switching frequency becomes highest when the ratio of the connected time of the switch to the disconnected time of the switch takes a predetermined setting value within a predetermined range including 1 (to be specific, a value in the range of 0.7 to 1.3).

The control circuit may include: an error amplifier circuit configured to generate a control voltage based on the output DC voltage; an oscillating circuit configured to generate a ramp voltage which increases and decreases repeatedly at the predetermined switching frequency; a comparator configured to generate a drive signal by comparing the control voltage and the ramp voltage, the drive signal causing the switch to perform switching; and a modulation signal generation circuit configured to output, to the oscillating circuit, such a modulation signal as to cause the switching frequency to increase in accordance with a decrease in an absolute value indicating a voltage difference between a median value of the ramp voltage and the control voltage. Accordingly, the less the difference between the control voltage and the median value of the ramp voltage, the closer the ratio of the connected time of the switch to the disconnected time of the switch is to 1. Therefore, a control circuit capable of effectively removing ripple noise can be realized with a simple configuration, by outputting to the oscillating circuit such a modulation signal as to cause the switching frequency to increase in accordance with a decrease in an absolute value indicating a voltage difference between the control voltage and the median value of the ramp voltage.

The control circuit may be configured to: detect an output voltage of the full-wave rectifier circuit and the output DC voltage; and calculate the ratio of the connected time of the switch to the disconnected time of the switch from the detected output voltage of the full-wave rectifier circuit and the detected output DC voltage. The ratio of the output DC voltage to the output voltage of the full-wave rectifier circuit corresponds to the ratio of the connected time of the switch to the disconnected time of the switch. Therefore, the ratio of the connected time of the switch to the disconnected time of the switch can be calculated with a simple configuration, by forming a control circuit configured to detect both the voltages and calculate the ratio of the connected time of the switch to the disconnected time of the switch based on these voltages.

The control circuit may be configured to vary the switching frequency such that the closer a ratio of a half value of the output DC voltage to the output voltage of the full-wave rectifier circuit is to a predetermined setting value within a predetermined range including 0.5, the higher the switching frequency. The predetermined range may be a range not less than 0.3 and not more than 0.7. The control circuit may be configured to vary the switching frequency such that the closer the ratio of the half value of the output DC voltage to the output voltage of the full-wave rectifier circuit is to 0.5, the higher the switching frequency.

It is considered that, ideally, the closer the ratio of the output DC voltage to the output voltage of the full-wave rectifier circuit is to a predetermined value within a predetermined range including 1 (i.e., the closer the ratio of the half value of the output DC voltage to the output voltage of the full-wave rectifier circuit is to 0.5), the greater the amplitude of the current flowing through the inductor. Accordingly, ideally, current ripple can be reduced more effectively by varying the switching frequency such that the closer the ratio of the half value of the output DC voltage to the output voltage of the full-wave rectifier circuit is to 0.5, the higher the switching frequency. Moreover, when the switching frequency is varied in accordance with the ratio of the output DC voltage to the output voltage of the full-wave rectifier circuit, the current flowing through the inductor varies, and the amplitude of the current varies, accordingly. Therefore, in reality, there is a case where the amplitude of the current becomes greatest when the ratio of the half value of the output DC voltage to the output voltage of the full-wave rectifier circuit is not at 0.5 but at a slightly shifted value. In view of this, ripple noise can be removed more effectively by performing setting such that the switching frequency becomes highest when the ratio of the half value of the output DC voltage to the output voltage of the full-wave rectifier circuit takes a predetermined value within a predetermined range including 0.5 (to be specific, a value in the range of 0.3 to 0.7).

The above and further objects, features, and advantages of the invention will more fully be apparent from the following detailed description with accompanying drawings.

The present invention is configured as described above, and provides an advantage of being able to remove sufficiently ripple noise due to the switching frequency, the ripple noise being superimposed on an AC line, thereby stabilizing an output voltage.

### BRIEF DESCRIPTION OF THE DRAWINGS

FIG. 1 is a circuit diagram showing a schematic configuration of a switching power supply device according to Embodiment 1 of the present invention.

FIG. 2 is a circuit diagram showing a schematic configuration of a modulation signal generation circuit of the switching power supply device shown in FIG. 1.

FIG. 3 is a graph showing signal waveforms of the switching power supply device shown in FIG. 1.

FIG. 4 is a graph showing a relationship of a switching frequency fs with a rectified voltage Vi and an output DC voltage Vo, the relationship being observed in the switching power supply device shown in FIG. 1.

FIG. 5 is a circuit diagram showing a schematic configuration of a switching power supply device according to Embodiment 2 of the present invention.

FIG. 6 is a circuit diagram showing a schematic configuration of a switching power supply device according to Embodiment 3 of the present invention.

FIG. 7 is a circuit diagram showing a configuration of a conventional switching power supply device.

### DESCRIPTION OF THE PREFERRED EMBODIMENTS

Hereinafter, embodiments of the present invention are described with reference to the drawings. In the drawings, the same or corresponding components are denoted by the same reference signs, and a repetition of the same description is avoided.

### Embodiment 1

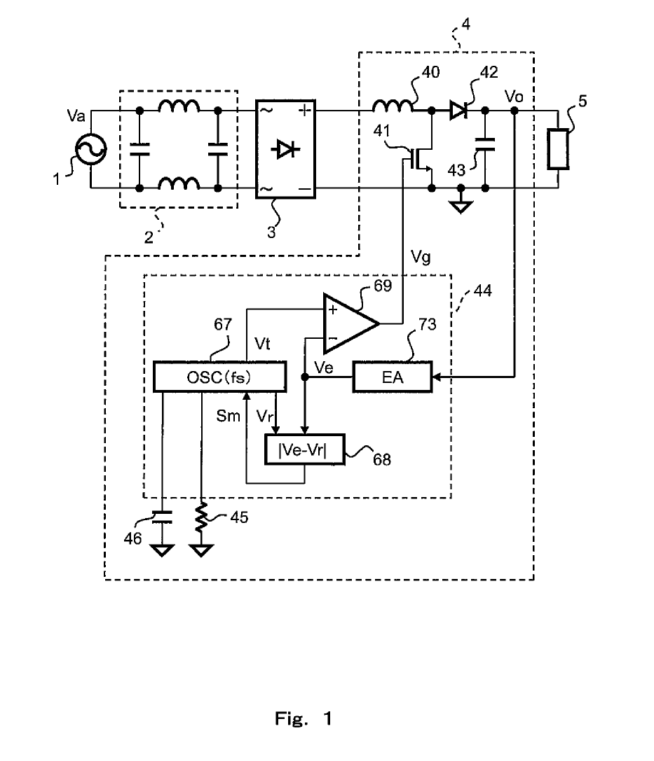

First, a description is given of a switching power supply device according to Embodiment 1 of the present invention. FIG. 1 is a circuit diagram showing a schematic configuration of the switching power supply device according to Embodiment 1 of the present invention.

As shown in FIG. 1, an AC power supply 1 configured to supply an input AC voltage Va is provided as a power supply for the switching power supply device according to the present embodiment. An input filter 2 is connected to an output terminal of the AC power supply 1. The input filter 2 filters an output from the AC power supply 1. The input filter 2 is a known low-pass filter including inductors and capacitors. A full-wave rectifier circuit 3 is connected to an output terminal of the input filter 2. The full-wave rectifier circuit 3 performs full-wave rectification of the input AC voltage Va, and outputs a resultant rectified voltage Vi. A boost converter 4 is provided between the full-wave rectifier circuit 3 and a load circuit 5. The boost converter 4 boosts the rectified voltage Vi to generate an output DC voltage Vo, and supplies the output DC voltage Vo to the load circuit 5.

The boost converter 4 includes: an inductor 40 whose one end is connected to a positive output terminal of the full-wave rectifier circuit 3; a switch 41 whose main terminal pair is connected between the other end of the inductor 40 and a negative output terminal of the full-wave rectifier circuit 3; a rectifier (diode) 42 whose anode terminal is connected to the other end of the inductor 40; and an output capacitor 43 connected to a cathode terminal of the diode 42. The diode 42 rectifies a current outputted from the inductor 40. The output capacitor 43 is charged with the current rectified by the diode 42. A voltage applied as a result of the output capacitor 43 being charged is the output DC voltage Vo supplied to the load circuit 5. The switch 41 includes a first main terminal and a second main terminal. The first main terminal is connected to the other end of the inductor 40. The second main terminal is connected to a predetermined constant power supply unit. In the switching power supply device according to the present embodiment, the switch 41 connects between the inductor 40 and the constant power supply unit (i.e., ON state), thereby storing energy in the inductor 40, and disconnects between the inductor 40 and the constant power supply unit (i.e., OFF state), thereby charging the output capacitor 43 with the energy stored in the inductor 40.

In the present embodiment, the switch 41 is configured as an N-channel MOSFET. It should be noted that the switch 41 need not be an N-channel MOSFET, but may be a P-channel MOSFET or a different transistor capable of performing switching operations such as a bipolar transistor. In the present embodiment, the constant power supply unit connected to the second main terminal of the switch 41 outputs a ground potential. However, as an alternative, the constant power supply unit may have a different predetermined potential.

In the present embodiment, the boost converter 4 further includes a control circuit 44 configured to drive the switch 41 at a predetermined switching frequency fs. The control circuit 44 is configured to vary the switching frequency fs in accordance with the ratio of a connected time Ton of the switch 41 to a disconnected time Toff of the switch 41. To be more specific, the control circuit 44 includes: an error amplifier circuit 73 configured to generate a control voltage Ve based on the output DC voltage Vo; an oscillating circuit 67 configured to generate a ramp voltage Vt which increases and decreases repeatedly at the predetermined switching frequency fs; a comparator 69 configured to generate a drive signal Vg by comparing the control voltage Ve and the ramp voltage Vt, the drive signal Vg causing the switch 41 to perform switching; and a modulation signal generation circuit 68 configured to output, to the oscillating circuit 67, such a modulation signal Sm as to cause the switching frequency fs to increase in accordance with a decrease in an absolute value |Ve−Vr| indicating a voltage difference between a median value Vr of the ramp voltage Vt and the control voltage Ve.

The boost converter 4 includes a resistance element 45 and a capacitor 46, which are connected to the oscillating circuit 67. The oscillating circuit 67 charges the capacitor 46 to a first threshold (highest voltage value) by using the sum of a current that is set based on the resistance value of the resistance element 45 and a current from the modulation signal generation circuit 68, and then rapidly discharges the capacitor 46 to a second threshold (lowest voltage value). The oscillating circuit 67 repeatedly performs the charging and the rapid discharging, thereby generating the ramp voltage Vt having the predetermined switching frequency fs and a sawtooth waveform. Also, the oscillating circuit 67 outputs the median value Vr, which is a median value between the first threshold and the second threshold. As described below, the modulation signal generation circuit 68 outputs the modulation signal Sm (modulation current Im), which is inversely proportional to the voltage difference between the control voltage Ve and the median value Vr. Accordingly, the modulation current Im becomes maximum when the control voltage Ve is equal to the median value Vr.

Hereinafter, a description is given of operations that the switching power supply device according to the present embodiment with the above-described configuration performs to stabilize the output DC voltage Vo. It should be noted that the switching frequency fs of the switch 41 in the present embodiment (tens of kHz to hundreds of kHz) is sufficiently higher than the input AC frequency of the input AC voltage Va (tens of Hz), and it is assumed that a variation in the rectified voltage Vi within a switching cycle of the switch 41 can be ignored.

First, when the switch 41 is turned ON, the rectified voltage Vi is applied to the inductor 40, and a linearly increasing current flows through the following path: AC power supply 1→input filter 2→full-wave rectifier circuit 3→inductor 40→switch 41→full-wave rectifier circuit 3→input filter 2→AC power supply 1. Accordingly, energy is stored in the inductor 40. If the ON period (connected time) of the switch 41 is Ton and the inductance of the inductor 40 is L, then an increase amount ΔIL1 of the current flowing through the inductor 40 during the connected time Ton is represented by an equation below.

ΔIL1=Vi×Ton/L (1)

Next, when the switch 41 is turned OFF, a differential voltage between the output DC voltage Vo and the rectified voltage Vi is applied to the inductor 40, and a linearly decreasing current flows through the following path: AC power supply 1→input filter 2→full-wave rectifier circuit 3→inductor 40→diode 42→output capacitor 43 and load circuit 5→full-wave rectifier circuit 3→input filter 2→input AC power supply 1. Accordingly, the energy stored in the inductor 40 is released and the output capacitor 43 is charged, and also, energy is supplied to the load circuit 5 based on the output DC voltage Vo applied to the output capacitor 43. If the OFF period (disconnected time) of the switch 41 is Toff, then a decrease amount ΔIL2 of the current flowing through the inductor 40 during the disconnected time Toff is represented by an equation below.

ΔIL2=(Vo−Vi)×Toff/L (2)

As described above, a triangular wave current (inductor current), in which linear increase and decrease are repeated in accordance with switching operations of the switch 41, flows through the inductor 40. An input alternating current supplied from the AC power supply 1 and flowing through an AC line is a result of the triangular-wave inductor current being averaged mainly by the input filter 2. If the proportion of the connected time Ton to a switching cycle T (=Ton+Toff), i.e., a duty ratio δ (=Ton/T), increases, then the increase amount ΔIL1 increases. This causes an increase in the inductor current. As a result, output power increases. In contrast, if the duty ratio δ decreases, the decrease amount ΔIL2 increases. This causes a decrease in the inductor current. As a result, output power decreases. That is, the inductor current and the output power can be controlled by adjusting the duty ratio δ.

In the control circuit 44, the drive signal Vg, which is a pulse signal for controlling the switching operation of the switch 41, is generated through a comparison by the comparator 69 between the control voltage Ve and the ramp voltage Vt generated by the oscillating circuit 67. The control voltage Ve is generated as a result of the error amplifier circuit 73 amplifying an error between the output DC voltage Vo and a reference voltage. For example, if a state where the output DC voltage Vo is higher than the reference voltage continues, then the control voltage Ve decreases and the duty ratio δ of the drive signal Vg decreases. This causes a decrease in the inductor current, and the output DC voltage Vo decreases, accordingly. In contrast, if a state where the output DC voltage Vo is lower than the reference voltage continues, then the control voltage Ve increases and the duty ratio δ of the drive signal Vg increases. This causes an increase in the inductor current, and the output DC voltage Vo increases, accordingly. Through the feedback thus described, the switching power supply device operates such that the output DC voltage Vo follows the reference voltage.

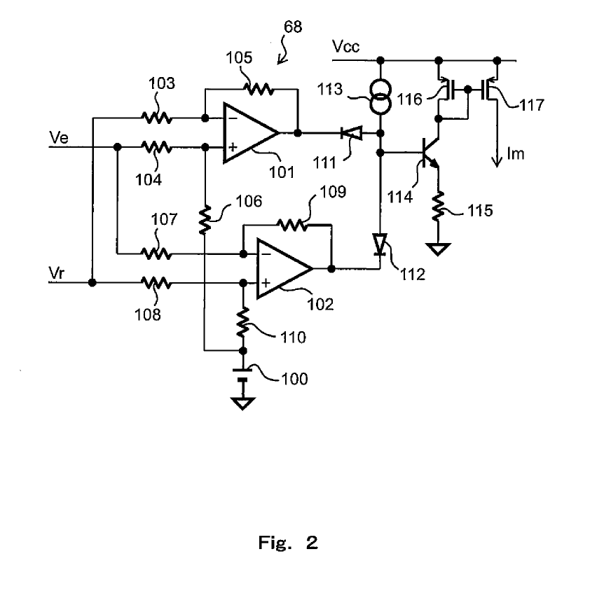

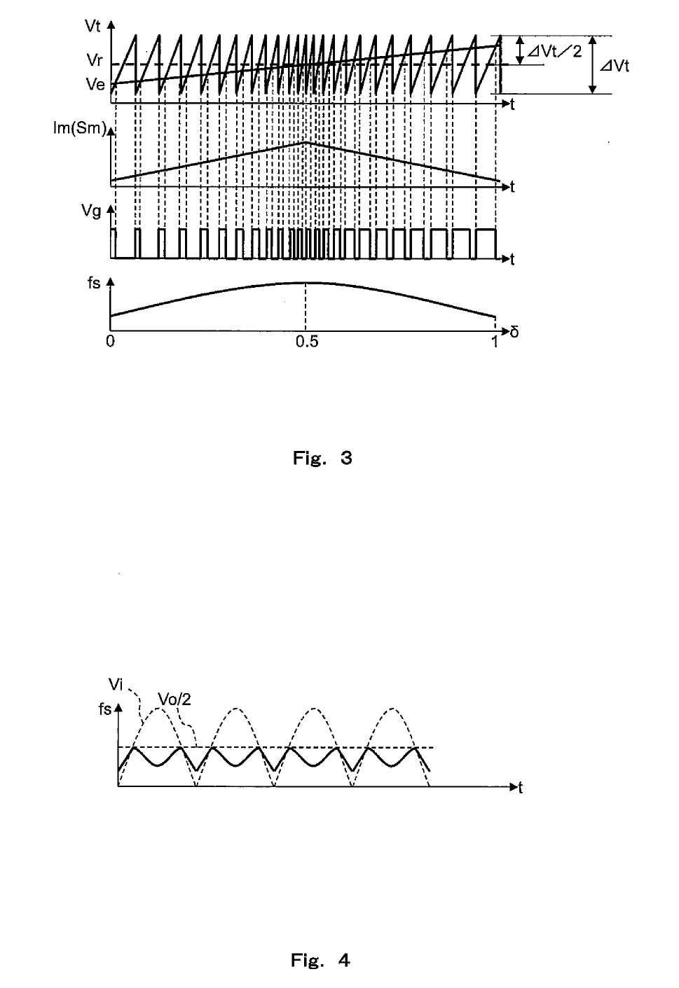

FIG. 2 is a circuit diagram showing a schematic configuration of the modulation signal generation circuit of the switching power supply device shown in FIG. 1. FIG. 3 is a graph showing signal waveforms of the switching power supply device shown in FIG. 1.

As shown in FIG. 2, the modulation signal generation circuit 68 according to the present embodiment includes: a reference voltage source 100 configured to generate a reference voltage E1; a first operational amplifier 101 configured to perform operational amplification based on the reference voltage E1 and the median value Vr of the ramp voltage Vt; and a second operational amplifier 102 configured to perform operational amplification based on the reference voltage E1 and the control voltage Ve. An input terminal for the control voltage Ve is connected to a non-inverting input terminal of the first operational amplifier 101 via a resistance element 104. An input terminal for the median value Vr is connected to an inverting input terminal of the first operational amplifier 101 via a resistance element 103. The input terminal for the median value Vr is also connected to a non-inverting input terminal of the second operational amplifier 102 via a resistance element 108. The input terminal for the control voltage Ve is also connected to an inverting input terminal of the second operational amplifier 102 via a resistance element 107. It should be noted that the resistance elements 103, 104, 107, and 108 have the same resistance value r. The reference voltage source 100 is connected to the non-inverting terminals of the first and second operational amplifiers 101 and 102 via resistance elements 106 and 110, respectively. The inverting terminals of the first and second operational amplifiers 101 and 102 are connected to respective output terminals via resistance elements 105 and 109. It should be noted that the resistance elements 105, 106, 109, and 110 have the same resistance value R.

Thus, the reference voltage source 100, the first operational amplifier 101, and the resistance elements 103 to 106 form a subtracting circuit configured to output an output voltage V1=E1+(R/r)×(Ve−Vr) from the output terminal of the first operational amplifier 101. The reference voltage source 100, the second operational amplifier 102, and the resistance elements 107 to 110 form a subtracting circuit configured to output an output voltage V2=E1+(R/r)×(Vr−Ve) from the output terminal of the second operational amplifier 102.

Diodes 111 and 112 are connected to the respective output terminals of the first and second operational amplifiers 101 and 102. The anodes of the diodes 111 and 112 are connected to a common terminal, and the cathodes of the diodes 111 and 112 are connected to the respective output terminals of the operational amplifiers 101 and 102. Accordingly, a voltage that is a result of adding one of the forward voltages of the diodes 111 and 112, the one forward voltage corresponding to a lower one of the output voltages V1 and V2 of the operational amplifiers 101 and 102, to the lower one of the output voltages V1 and V2 occurs at the anode-side common terminal for the diodes 111 and 112.

A current source 113 and the base of an NPN transistor 114 are connected to the anode-side common terminal for the diodes 111 and 112. The emitter of the transistor 114 is connected to a constant voltage unit (e.g., to the ground) via a resistance element 115 (having a resistance value R15). Accordingly, a lower one of the output voltages V1 and V2 of the operational amplifiers 101 and 102 (i.e., E1−(R/r)×|Ve−Vr|) occurs at the emitter of the transistor 114. A current whose value is obtained by dividing the lower voltage by the resistance value R15 of the resistor 115 flows through the transistor 114.

A current mirror circuit including two P-type transistors 116 and 117 is connected to the collector of the transistor 114. The modulation current Im corresponding to the current flowing through the transistor 114 is outputted from the collector of the transistor 117. Assuming that the mirror ratio between the transistors 116 and 117 is 1:1, the modulation current Im is equal to the current flowing through the transistor 114, and is represented by an equation shown below.

IM=(E1−(R/r)×|Ve−Vr|)/R15 (3)

As shown in FIG. 1, the modulation current Im is inputted into the oscillating circuit 67 as the modulation signal Sm. In the oscillating circuit 67, the ramp voltage (sawtooth-wave voltage) Vt having the median value Vr as a central value is generated. At the time, the charging current for charging the capacitor 46 is a result of adding the above modulation current Im to a current Ic set by the resistance element 45. If the capacitance of the capacitor 46 is Ct and the amplitude of the ramp voltage Vt is ΔVt, the switching cycle T is represented by an equation shown below.

T=Ct×ΔVt/(Ic+Im) (4)

As shown in the equation (3), ideally, the closer the control voltage Ve is to the median value Vr of the ramp voltage Vt, the greater the modulation current Im. Accordingly, ideally, the closer the control voltage Ve is to the median value Vr of the ramp voltage Vt, the shorter the switching cycle T of the ramp voltage Vt. The pulse width of the drive signal Vg to the switch 41 is set based on the comparison between the control voltage Ve and the ramp voltage Vt. Therefore, as shown in FIG. 3, ideally, the frequency becomes highest when the control voltage Ve is equal to the median value Yr. At the time, the duty ratio δ of the drive signal Vg is δ=0.5. That is, the ratio of the connected time Ton of the switch 41 to the disconnected time Toff of the switch 41 is 1. As shown in FIG. 3, the duty ratio δ of the drive signal Vg (i.e., a pulse width for turning ON the switch 41) increases in accordance with an increase in the control voltage Ve. If the duty ratio is in the range of δ<0.5, the frequency increases in accordance with an increase in the control voltage Ve and the frequency becomes highest when δ=0.5. If the duty ratio is in the range of δ>0.5, the frequency decreases in accordance with an increase in the control voltage Ve.

As described above, in the switching power supply device according to the present embodiment, ideally, the closer the duty ratio δ is to 0.5, the higher the switching frequency fs.

Since the average value of the inductor current varies from moment to moment due to PFC operation, the equation (1) indicating an increase amount of the current in the ON period and the equation (2) indicating a decrease amount of the current in the OFF period are not exactly equal to each other. However, looking at inductor current values before and after one switching cycle, the increase amount in the ON period and the decrease amount in the OFF period are considered to be substantially equal to each other. Accordingly, assuming that the equation (1) is equal to the equation (2), the amplitude AI of the inductor current is represented by an equation below.

ΔI=Vi×Ton/L=(Vo−Vi)×Toff/L (5)

Since T=Ton+Toff, the equation (5) can be modified as shown below.

ΔI=(1−Vi/Vo)×(Vi/Vo)×Vo×T/L (6)

Assuming that Vo×T/L is constant, the amplitude AI of the inductor current becomes greatest when Vi/Vo=0.5. Based on the equation (5), if Vi/Vo=0.5, then Ton=Toff. Accordingly, the amplitude AI of the inductor current becomes greatest when the duty ratio δ=0.5.

The input filter 2 used in the switching power supply device is a low-pass filter configured to remove ripple noise due to the switching frequency fs from the AC line. Accordingly, it is considered that the lower the switching frequency fs of the switching power supply device, the lower the noise attenuation rate. In conventional switching power supply devices, the switching frequency fs is modulated in accordance with an input AC voltage regardless of the amplitude of a current flowing through an inductor. Accordingly, in a case where ripple noise becomes great due to an increase in the amplitude of the current flowing through the inductor, a state where the switching frequency fs is lowered may occur. Therefore, in conventional switching power supply devices, it is considered that in a case where the amplitude of the current flowing through the inductor has increased, if the switching frequency fs is lowered, then the effect of noise attenuation by an input filter is reduced, resulting in an increase in ripple noise superimposed on an AC line.

Meanwhile, in the switching power supply device according to the present embodiment, the switching frequency fs varies in accordance with the ratio of the connected time Ton of the switch 41 to the disconnected time Toff of the switch 41 (this ratio is substantially equivalent to the duty ratio δ). That is, if the output DC voltage Vo is constant, the switching frequency fs is modulated such that the switching frequency fs becomes highest when the duty ratio δ=0.5, under which condition the amplitude ΔI of the inductor current is great. FIG. 4 is a graph showing a relationship of the switching frequency fs with the rectified voltage Vi and the output DC voltage Vo, the relationship being observed in the switching power supply device shown in FIG. 1. As shown in FIG. 4, when Vi/Vo=0.5 (i.e., when Vi=Vo/2), under which condition the duty ratio δ is 0.5, the switching frequency fs becomes highest.

That is, in the switching power supply device according to the present embodiment, setting is made such that, at the time of spreading the switching frequency fs, the switching frequency fs becomes high when the amplitude of the inductor current is great. In this respect, the present embodiment gives a specific method, in which: the frequency of the ramp voltage Vt (switching frequency fs) is varied in accordance with the level of the control voltage Ve; then the ramp voltage Vt and the control voltage Ve are compared by the comparator 69; and the drive signal Vg based on the comparison, the drive signal Vg setting the ON period and the OFF period of the switch 41, is outputted.

As described above, it is considered that the amplitude of the current flowing through the inductor varies in accordance with the duty ratio δ. Therefore, by varying the switching frequency fs in accordance with the duty ratio δ, the switching frequency fs when the ripple component of the inductor current is great can be made high. As a result, not only is a noise reduction effect owing to the spreading of the switching frequency fs obtained, but also the amplitude AI of the inductor current is suppressed and the attenuation effect of the input filter 2 is improved. Consequently, ripple noise superimposed on the AC line can be sufficiently removed, and the power factor of an input from the AC power supply 1 can be improved. In particular, ripple noise can be effectively removed even if the inductor 40 has a low time constant.

As described above, it is considered that, ideally, the closer the duty ratio δ of the switch 41 is to 0.5 (i.e., the closer the connected time/disconnected time ratio Ton/Toff is to 1), the greater the amplitude of the current flowing through the inductor. However, when the switching frequency fs is varied in accordance with the duty ratio of the switch 41, the current flowing through the inductor 40 varies, and the amplitude of the current varies, accordingly. Therefore, in reality, it is considered that the amplitude of the current becomes greatest when the duty ratio δ of the switch 41 is not at 0.5 but at a slightly shifted value. In view of this, ripple noise can be removed more effectively by performing setting such that the switching frequency becomes highest when the ratio of the connected time Ton of the switch 41 to the disconnected time Toff of the switch 41 takes a predetermined setting value within a predetermined range including 1 (to be specific, a value in the range of 0.7 to 1.3, i.e., a value in the range of 0.3≦δ≦0.7 in the case of the duty ratio δ).

### Embodiment 2

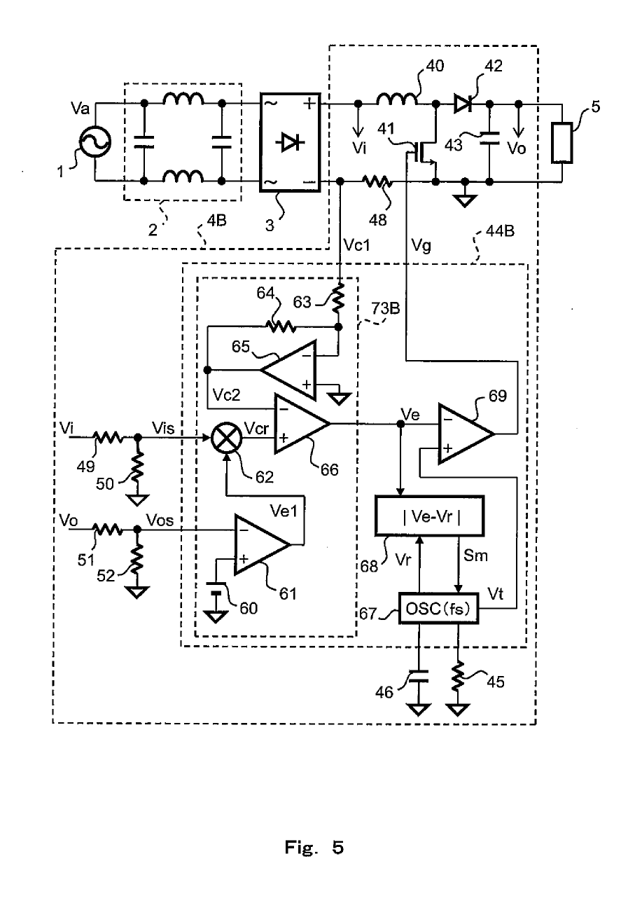

Next, a switching power supply device according to Embodiment 2 of the present invention is described. FIG. 5 is a circuit diagram showing a schematic configuration of the switching power supply device according to Embodiment 2 of the present invention. In the present embodiment, the same components as those described in Embodiment 1 are denoted by the same reference signs as those used in Embodiment 1, and a description of such components is omitted. The switching power supply device according to the present embodiment is different from the switching power supply device according to Embodiment 1, in that in the switching power supply device according to the present embodiment, as shown in FIG. 5, a control circuit 44B of a boost converter 4B is configured to generate the control voltage Ve not only based on the output DC voltage Vo but also based on the rectified voltage Vi outputted from the full-wave rectifier circuit 3 and the inductor current flowing through the inductor 40. Specifically, instead of the error amplifier circuit 73 according to Embodiment 1, the control circuit 44B according to the present embodiment includes an error amplifier circuit 73B configured to generate the control voltage Ve based on the following voltages inputted into the error amplifier circuit 73B: a first current detection voltage Vc1 applied to a detecting resistance element 48 configured to detect the inductor current flowing through the inductor 40; an input detection voltage Vis based on the rectified voltage Vi; and an output detection voltage Vos based on the output DC voltage Vo.

In the present embodiment, the detecting resistance element 48 is connected between the negative output terminal of the full-wave rectifier circuit 3 and the constant power supply unit (i.e., the ground) connected to the second main terminal of the switch 41. It should be noted that the detecting resistance element 48 may be provided at any position in the boost converter 4B, so long as the detecting resistance element 48 can detect the inductor current.

The boost converter 4B includes: resistance elements 49 and 50 configured to divide the rectified voltage Vi and apply a resultant input detection voltage Vis to the control circuit 44B; and resistance elements 51 and 52 configured to divide the output DC voltage Vo and apply a resultant output detection voltage Vos to the control circuit 44B.

The error amplifier circuit 73B according to the present embodiment includes: a reference voltage source 60 configured to generate a reference voltage Er; a first error amplifier 61 configured to amplify an error between the output detection voltage Vos and the reference voltage Er, and output a first error voltage Ve1; and a multiplier 62 configured to output a voltage (multiplier output voltage) Vcr proportional to the product of the input detection voltage Vis and the first error voltage Ve1. If the proportionality constant of the multiplier 62 is K, the multiplier output voltage Vcr is represented by Vcr=K×Vis×Ve1.

The error amplifier circuit 73B further includes an inverting amplifier. The inverting amplifier includes resistance elements 63 and 64 and an operational amplifier 65. The inverting amplifier outputs a second current detection voltage Vc2. The second current detection voltage Vc2 is obtained by amplifying and inverting the first current detection voltage Vc1, which is a negative potential, to a positive potential.

The error amplifier circuit 73B further includes a second error amplifier 66 configured to output a second error voltage Ve. The second error voltage Ve is obtained by amplifying an error between the second current detection voltage Vc2 and the multiplier output voltage Vcr outputted from the multiplier 62. The second error voltage Ve is inputted into the comparator 69 and the modulation signal generation circuit 68 as a control voltage. As with Embodiment 1, the modulation signal generation circuit 68 outputs the modulation signal Sm (modulation current Im) which is inversely proportional to the voltage difference between the control voltage Ve and the median value Yr. Moreover, as with Embodiment 1, the comparator 69 generates the drive signal Vg, which is a result of comparing the control voltage Ve and the ramp voltage Vt, and the switch 41 is driven based on the drive signal Vg.

In the control circuit 44B, the drive signal Vg, which causes the switch 41 to perform a switching operation, is generated through the comparison of the control voltage Ve with the ramp voltage Vt. The control voltage Ve is the second error voltage, which is obtained by amplifying the error between the second current detection voltage Vc2 based on the inductor current and the multiplier output voltage Vcr. For example, if a state where the second current detection voltage Vc2 is higher than the multiplier output voltage Vcr continues, then the control voltage Ve decreases and the duty ratio δ of the pulse of the drive signal Vg decreases. This causes a decrease in the inductor current, and the first current detection voltage Vc1 decreases, accordingly. In contrast, if a state where the second current detection voltage Vc2 is lower than the multiplier output voltage Vcr continues, then the control voltage Ve increases and the duty ratio δ of the pulse of the drive signal Vg increases. This causes an increase in the inductor current, and the first current detection voltage Vc1 increases, accordingly. Through the feedback thus described, the switching power supply device according to the present embodiment operates such that the first current detection voltage Vc1 follows the multiplier output voltage Vcr. That is, the switching power supply device according to the present embodiment operates such that an input alternating current, which is an average value of the inductor current, is proportional to the multiplier output voltage Vcr.

The multiplier output voltage Vcr is proportional to a value obtained by multiplying the first error voltage Ve1 and the input detection voltage Vis. The first error voltage Ve1 is obtained as a result of the output detection voltage Vos being compared with the reference voltage Er and amplified by the error amplifier 61. If the response frequency of the error amplifier 61 is set to be sufficiently lower than the input AC frequency, then the first error voltage Ve1 will become a DC value that rarely varies over one cycle of the rectified voltage Vi. Accordingly, the multiplier output voltage Vcr is proportional to the input detection voltage Vis, which has a full-wave rectification waveform, and the multiplier output voltage Vcr has a waveform whose wave height value increases and decreases in accordance with the first error voltage Ve1. For example, if a state where the output detection voltage Vos is higher than the reference voltage Er continues, then the first error voltage Ve1 decreases and the wave height value of the multiplier output voltage Vcr decreases. This causes a decrease in the input alternating current, and the output detection voltage Vos decreases, accordingly. In contrast, if a state where the output detection voltage Vos is lower than the reference voltage Er continues, then the first error voltage Ve1 increases and the wave height value of the multiplier output voltage Vcr increases. This causes an increase in the input alternating current, and the output detection voltage Vos increases, accordingly. Through the feedback thus described, the switching power supply device operates in a manner to adjust the amplitude of the input alternating current such that the output voltage Vo is stabilized. As a result, the input alternating current is proportional to the input AC voltage.

The equations (1) to (6) described in Embodiment 1 hold true also for the switching power supply device according to the present embodiment with the above-described configuration. Assuming that Vo×T/L is constant, the amplitude AI of the inductor current becomes greatest when Vi/Vo=0.5. It is understood from the equation (5) that Ton=Toff when Vi/Vo=0.5. Accordingly, the amplitude AI of the inductor current becomes greatest when the duty ratio δ=0.5.

As described above, the switching power supply device according to the present embodiment is capable of controlling the average value of the inductor current by detecting not only the output DC voltage Vo but also the voltage based on the inductor current, thereby stabilizing the output voltage and the input alternating current.

### Embodiment 3

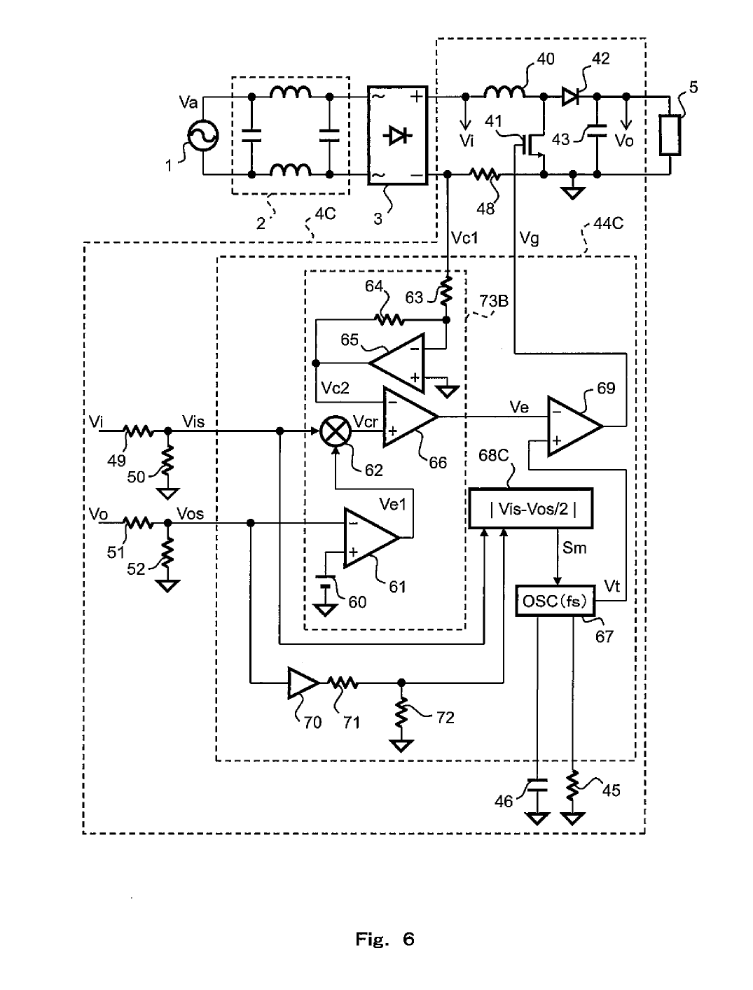

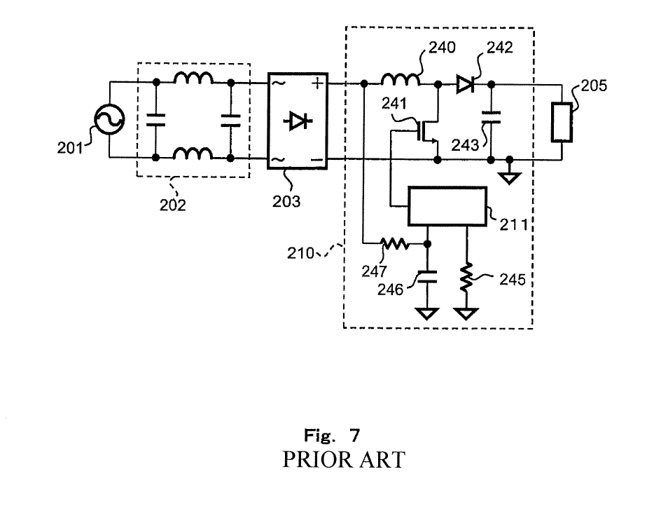

Next, a switching power supply device according to Embodiment 3 of the present invention is described. FIG. 6 is a circuit diagram showing a schematic configuration of the switching power supply device according to Embodiment 3 of the present invention. In the present embodiment, the same components as those described in Embodiment 2 are denoted by the same reference signs as those used in Embodiment 2, and a description of such components is omitted. The switching power supply device according to the present embodiment is different from the switching power supply device according to Embodiment 2, in that in the switching power supply device according to the present embodiment, as shown in FIG. 6, a control circuit 44C of a boost converter 4C is configured such that a voltage not based on the control voltage Ve and the median value Vr of the ramp voltage Vt but based on the input detection voltage Vis and the output detection voltage Vos is inputted into a modulation signal generation circuit 68C. Accordingly, the control circuit 44C is configured to estimate the ratio of the connected time Ton of the switch 41 to the disconnected time Toff of the switch 41, by detecting the output voltage (rectified voltage) Vi of the full-wave rectifier circuit 3 and the output DC voltage Vo. Specifically, the input detection voltage Vis is inputted into the modulation signal generation circuit 68C as an input voltage corresponding to the control voltage Ve, and a predetermined partial voltage value (e.g., half value) of the output detection voltage Vos is inputted into the modulation signal generation circuit 68C as an input voltage corresponding to the median value Vr of the ramp voltage Vt.

The control circuit 44C includes: resistance elements 71 and 72 configured to divide the output detection voltage Vos; and a buffer 70 which is provided between the resistance elements 51 and 52 and the resistance elements 71 and 72, the resistance elements 51 and 52 being configured to generate the output detection voltage Vos, so that a partial voltage resulting from the voltage division by the resistance elements 51 and 52 will not be affected by the resistance elements 71 and 72. For example, by equalizing the resistance values of the resistance elements 71 and 72 in relation to each other, the output detection voltage Vos is divided into half. Moreover, in the present embodiment, in order to detect a voltage corresponding to a voltage difference between the rectified voltage Vi and the half voltage of the output DC voltage Vo, the resistance values of the respective resistance elements are set such that the voltage division ratio between the resistance elements 49 and 50 configured to divide the rectified voltage Vi, and the voltage division ratio between the resistance elements 51 and 52 configured to divide the output DC voltage Vo, are equal to each other.

Also in the switching power supply device according to the present embodiment, the configuration of the modulation signal generation circuit 68C may be the same as the circuit configuration shown in FIG. 2. In this case, the modulation current Im, which is the modulation signal Sm, is represented by an equation below.

Im=(E1−(R/r)×|Vis−Vos/2|)/R15 (7)

As described in Embodiment 1, the amplitude AI of the inductor current becomes greatest when Vi/Vo=0.5. Accordingly, the switching frequency fs is modulated such that the switching frequency fs becomes highest when the rectified voltage Vi is half of the output DC voltage Vo. As previously described, the ratio of the output DC voltage Vo to the rectified voltage Vi which is an output voltage of the full-wave rectifier circuit 3 corresponds to the ratio of the connected time Ton of the switch 41 to the disconnected time Toff of the switch 41. Therefore, by forming the control circuit 44C configured to detect both the voltages, the ratio of the connected time Ton of the switch 41 to the disconnected time Toff of the switch 41 can be calculated with a simple configuration.

It should be noted that, in the present embodiment, other than the resistance elements 51 and 52 configured to divide the output DC voltage Vo, the buffer 70 and the resistance elements 71 and 72 are used to further divide the output DC voltage Vo. However, the present embodiment is not thus limited, so long as the present embodiment is configured to properly detect and compare the rectified voltage Vi and the output DC voltage Vo. For example, the buffer 70 and the resistance elements 71 and 72 may be eliminated, in which case the voltage division ratio between the resistance elements 51 and 52 configured to divide the output DC voltage Vo may be set to be half of the voltage division ratio between the resistance elements 49 and 50 configured to divide the rectified voltage Vi, and the value of the reference voltage Er of the reference voltage source 60 may be set to be half of the value in Embodiment 2. As an alternative, the voltage division ratio between the resistance elements 49 and 50 configured to divide the rectified voltage Vi may be set to be twice as great as the voltage division ratio between the resistance elements 51 and 52 configured to divide the output DC voltage Vo, and the value of the proportionality constant K of the multiplier 62 may be set to be half of the value in Embodiment 2.

As with Embodiment 1, in the present embodiment, in reality, it is considered that the amplitude of the current becomes greatest when the duty ratio δ of the switch 41 is not at 0.5 but at a slightly shifted value. In view of this, ripple noise can be removed more effectively by performing setting such that the switching frequency becomes highest when Vi/Vo takes a predetermined setting value within a predetermined range including 0.5 (to be specific, a value in the range of 0.3≦Vi/Vo≦0.7).

In Embodiments 2 and 3, the control circuits 44B and 44C are configured to control the average value of the inductor current. However, as an alternative example, the control circuits 44B and 44C may be configured to control the peak value of the inductor current. Such a configuration also makes it possible to stabilize the output voltage and the input alternating current.

Although the preferred embodiments of the present invention are described above, the present invention is not limited to the above embodiments, and various improvements, alterations, and modifications can be made to the above embodiments without departing from the spirit of the present invention. For example, the components in the plurality of above-described embodiments and variations may be combined in any manner.

From the foregoing description, numerous modifications and other embodiments of the present invention are obvious to one skilled in the art. Therefore, the foregoing description should be interpreted only as an example and is provided for the purpose of teaching the best mode for carrying out the present invention to one skilled in the art. The structural and/or functional details may be substantially altered without departing from the spirit of the present invention.

### Industrial Applicability

The switching power supply device according to the present invention is useful for sufficiently removing ripple noise due to the switching frequency, the ripple noise being superimposed on an AC line, thereby stabilizing an output voltage.

What is claimed is:

1. A switching power supply device comprising:
an input filter configured to filter an input AC output from an AC power supply;
a full-wave rectifier circuit configured to perform full-wave rectification of the filtered input AC output;
an inductor whose one end is connected to an output terminal of the full-wave rectifier circuit;
a rectifier connected to another end of the inductor and configured to rectify a current outputted from the inductor;
an output capacitor connected to an output terminal of the rectifier, the output capacitor being configured to be charged in accordance with the current outputted from the inductor and generate an output DC voltage outputted to a load circuit;
a switch including a first main terminal and a second main terminal, the first main terminal being connected to the other end of the inductor, the second main terminal being connected to a predetermined constant power supply unit, the switch being configured to connect or disconnect between the inductor and the constant power supply unit; and
a control circuit configured to drive the switch at a predetermined switching frequency, wherein
the control circuit varies the switching frequency in accordance with a ratio of a connected time of the switch to a disconnected time of the switch, and
the control circuit varies the switching frequency such that the closer the ratio of the connected time of the switch to the disconnected time of the switch is to a predetermined setting value, the higher the switching frequency.

2. The switching power supply device according to claim 1, wherein the predetermined setting value is a value set within a predetermined range which is not less than 0.7 and not more than 1.3.

3. The switching power supply device according to claim 1, wherein the control circuit varies the switching frequency such that the closer the ratio of the connected time of the switch to the disconnected time of the switch is to 1, the higher the switching frequency.

4. The switching power supply device according to claim 1, wherein the control circuit includes:
an error amplifier circuit configured to generate a control voltage based on the output DC voltage;
an oscillating circuit configured to generate a ramp voltage which increases and decreases repeatedly at the predetermined switching frequency;
a comparator configured to generate a drive signal by comparing the control voltage and the ramp voltage, the drive signal causing the switch to perform switching; and
a modulation signal generation circuit configured to output, to the oscillating circuit, such a modulation signal as to cause the switching frequency to increase in accordance with a decrease in an absolute value indicating a voltage difference between a median value of the ramp voltage and the control voltage.

5. A switching power supply device comprising:
an input filter configured to filter an input AC output from an AC power supply;
a full-wave rectifier circuit configured to perform full-wave rectification of the filtered input AC output;
an inductor whose one end is connected to an output terminal of the full-wave rectifier circuit;
a rectifier connected to another end of the inductor and configured to rectify a current outputted from the inductor;
an output capacitor connected to an output terminal of the rectifier, the output capacitor being configured to be charged in accordance with the current outputted from the inductor and generate an output DC voltage outputted to a load circuit;
a switch including a first main terminal and a second main terminal, the first main terminal being connected to the other end of the inductor, the second main terminal being connected to a predetermined constant power supply unit, the switch being configured to connect or disconnect between the inductor and the constant power supply unit; and
a control circuit configured to drive the switch at a predetermined switching frequency, wherein
the control circuit varies the switching frequency in accordance with a ratio of a connected time of the switch to a disconnected time of the switch, and
the control circuit is configured to:
detect an output voltage of the full-wave rectifier circuit and the output DC voltage; and
calculate the ratio of the connected time of the switch to the disconnected time of the switch from the detected output voltage of the full-wave rectifier circuit and the detected output DC voltage.

6. The switching power supply device according to claim 5, wherein
the control circuit varies the switching frequency such that the closer a ratio of a half value of the output DC voltage to the output voltage of the full-wave rectifier circuit is to a predetermined setting value within a predetermined range including 0.5, the higher the switching frequency.

7. The switching power supply device according to claim 6, wherein the predetermined range is not less than 0.3 and not more than 0.7.

8. The switching power supply device according to claim 5, wherein the control circuit varies the switching frequency such that the closer the ratio of the half value of the output DC voltage to the output voltage of the full-wave rectifier circuit is to 0.5, the higher the switching frequency.
